(19) United States
(12) Patent Application Publication
(10) Pub. No.: US 2024/0336258 A1
(43) Pub. Date: Oct. 10, 2024

(54) DEVICE AND METHOD FOR CONTROLLING A VEHICLE

(71) Applicants: HYUNDAI MOTOR COMPANY, Seoul (KR); KIA CORPORATION, Seoul (KR)

(72) Inventor: Il Hwan Kim, Hwaseong-si (KR)

(73) Assignees: HYUNDAI MOTOR COMPANY, Seoul (KR); KIA CORPORATION, Seoul (KR)

(21) Appl. No.: 18/505,909

(22) Filed: Nov. 9, 2023

(30) Foreign Application Priority Data
Apr. 6, 2023 (KR) 10-2023-0045433

(51) Int. Cl. B60W 30/09; B60W 30/095; B60W 30/18

(52) U.S. Cl. CPC B60W 30/09; B60W 30/0956; B60W 30/181; B60W 30/18163; B60W 2554/80

(57) ABSTRACT

A device and a method for controlling a vehicle are disclosed. The vehicle control device includes a sensor device, a control module, and a processor. The sensor device detects a preceding vehicle of the vehicle. The control module controls driving and steering of the vehicle. The processor calculates a braking distance of the preceding vehicle based on a maximum deceleration of the preceding vehicle. The processor also calculates a safe stopping distance for providing a criterion for determining a risk of collision in a case of sudden braking in proportion to the braking distance of the preceding vehicle. The processor further determines a risk of collision with the preceding vehicle based on the safe stopping distance and controls the control module based on the risk of collision.

### CROSS-REFERENCE TO RELATED APPLICATION

This application claims the benefit of and priority to Korean Patent Application No. 10-2023-0045433, filed in the Korean Intellectual Property Office on Apr. 6, 2023, the entire contents of which are incorporated herein by reference.

### TECHNICAL FIELD

The present disclosure relates to a device and a method for controlling a vehicle, and more particularly, to a technology for preventing a risk of collision with a preceding vehicle.

### BACKGROUND

An autonomous vehicle is a vehicle that recognizes a driving environment without direct manipulation by a driver to determine a danger, plans a driving route to minimize driving manipulation of the driver, and drives safely by itself.

In the autonomous vehicle, vehicle driving control such as steering, acceleration, and braking may be performed in a manual driving mode or an autonomous driving mode. For example, a vehicle driving based on an automated lane keeping system (ALKS) needs to drive while maintaining a following distance sufficient to avoid a collision even when a preceding vehicle suddenly brakes.

However, because vehicles generally have different sudden braking performances, risks of collision with particular preceding vehicles may be different from each other even when the same following distance between an autonomous vehicle and the preceding vehicle is maintained.

### SUMMARY

Therefore, there is a need for a method capable of maintaining safe driving in view of the different sudden braking performances of the respective vehicles while minimizing traffic congestion.

The present disclosure has been made to solve the above-mentioned problems occurring in the prior art while advantages achieved by the prior art are maintained intact.

Aspects of the present disclosure provide a device and a method for controlling a vehicle capable of determining safety of the vehicle in motion in view of different sudden braking performances of preceding vehicles.

Other aspects of the present disclosure provide a device and a method for controlling a vehicle capable of safely controlling the vehicle in view of different sudden braking performances of preceding vehicles.

The technical problems to be solved by the present disclosure are not limited to the aforementioned problems. Other technical problems not mentioned herein should be more clearly understood by those having ordinary skill in the art to which the present disclosure pertains from the following description and the accompanying drawings.

According to an embodiment of the present disclosure, a device for controlling a vehicle is provided. The device includes a sensor device, a control module, and a processor. The sensor device is configured to detect a preceding vehicle of the vehicle. The control module is configured to control driving and steering of the vehicle. The processor is configured to calculate a braking distance of the preceding vehicle based on a maximum deceleration of the preceding vehicle. The processor is also configured to calculate a safe stopping distance for providing a criterion for determining a risk of collision in a case of sudden braking in proportion to the braking distance of the preceding vehicle. The processor is further configured to determine a risk of collision with the preceding vehicle based on the safe stopping distance. The processor is additionally configured to control the control module based on the risk of collision.

In an aspect, the device may further include a communication device configured to receive information on the maximum deceleration from the preceding vehicle.

In an aspect, the processor may be configured to output the maximum deceleration via artificial intelligence learning with a size and a manufacturer of the preceding vehicle as input values.

In an aspect, the processor may be configured to calculate the safe stopping distance to be greater as an inter-vehicle distance with the preceding vehicle and the braking distance of the preceding vehicle increase.

In an aspect, the processor may be configured to obtain a safe stopping margin distance by calculating a difference between the braking distance of the preceding vehicle and a preset collision-avoiding safety distance and by calculating the safe stopping distance by calculating a sum of the inter-vehicle distance and the safe stopping margin distance.

In an aspect, the processor may be configured to control the control module to maintain a driving state such that the inter-vehicle distance is not reduced when the safe stopping distance exceeds a stopping distance.

In an aspect, the processor may be configured to determine that the vehicle is located within a collision risk area and output an alarm via an alarm device when the stopping distance is equal to or greater than the safe stopping distance and is smaller than a sum of the safe stopping distance and the collision-avoiding safety distance.

In an aspect, the processor may be configured to determine whether a lane change is possible when it is determined that the vehicle is within the collision risk area.

In an aspect, the processor may be configured to determine that the vehicle is located within a collision area and attempt to perform a lane change when the stopping distance is equal to or greater than the sum of the safe stopping distance and the collision-avoiding safety distance.

In an aspect, the processor may be configured to decelerate the vehicle when the lane change is impossible.

According to another embodiment of the present disclosure, a method for controlling a vehicle is provided. The method includes identifying a maximum deceleration of a preceding vehicle. The method also includes calculating a braking distance of the preceding vehicle based on the maximum deceleration of the preceding vehicle. The method additionally includes calculating a safe stopping distance for providing a criterion for determining a risk of collision in a case of sudden braking in proportion to the braking distance of the preceding vehicle. The method further includes determining a risk of collision with the preceding vehicle based on the safe stopping distance. The method also includes controlling a control module configured to control driving and steering of the vehicle, based on the risk of collision.

In an aspect, identifying the maximum deceleration of the preceding vehicle may include receiving, via a communication device, information on the maximum deceleration from the preceding vehicle.

In an aspect, identifying of maximum deceleration of the preceding vehicle may include outputting the maximum deceleration via artificial intelligence learning with a size and a manufacturer of the preceding vehicle as input values.

In an aspect, calculating the safe stopping distance may include calculating the safe stopping distance to be greater as an inter-vehicle distance with the preceding vehicle and the braking distance of the preceding vehicle increase.

In an aspect, calculating the safe stopping distance may include calculating the inter-vehicle distance. Calculating the safe stopping distance may also include obtaining a safe stopping margin distance by calculating a difference between the braking distance of the preceding vehicle and a preset collision-avoiding safety distance. Calculating the safe stopping distance may additionally include calculating the safe stopping distance by calculating a sum of the inter-vehicle distance and the safe stopping margin distance.

In an aspect, controlling the control module based on the risk of collision may include maintaining a driving state such that the inter-vehicle distance is not reduced when the safe stopping distance exceeds a stopping distance.

In an aspect, controlling the control module based on the risk of collision may further include outputting an alarm notifying that the vehicle is located within a collision risk area when the stopping distance is equal to or greater than the safe stopping distance and is smaller than a sum of the safe stopping distance and the collision-avoiding safety distance.

In an aspect, controlling the control module based on the risk of collision may further include determining whether a lane change is possible when it is determined that the vehicle is within the collision risk area.

In an aspect, controlling the control module based on the risk of collision may further include determining that the vehicle is located within a collision area and attempt to perform a lane change when the stopping distance is equal to or greater than the sum of the safe stopping distance and the collision-avoiding safety distance.

In an aspect, controlling the control module based on the risk of collision may further include decelerating the vehicle when the lane change is impossible.

### BRIEF DESCRIPTION OF THE DRAWINGS

The above and other objects, features, and advantages of the present disclosure should be more apparent from the following detailed description taken in conjunction with the accompanying drawings, in which:

FIG. 1 is a diagram illustrating a vehicle including a vehicle control device, according to an embodiment of the present disclosure;

FIG. 2 is a block diagram showing a configuration of a vehicle control device, according to an embodiment of the present disclosure;

FIG. 3 is a flowchart illustrating a method for controlling a vehicle, according to an embodiment of the present disclosure;

FIG. 4 is a diagram illustrating an artificial neural network (ANN) for setting a maximum deceleration, according to an embodiment of the present disclosure;

FIG. 5 is a diagram illustrating a braking distance, according to an embodiment of the present disclosure;

FIG. 6 is a diagram illustrating a stopping distance, according to an embodiment of the present disclosure;

FIG. 7 is a diagram illustrating a safe stopping distance, according to an embodiment of the present disclosure;

FIG. 8 is a diagram illustrating a driving state determined as a state driving in a safe driving area, according to an embodiment of the present disclosure;

FIG. 9 is a diagram illustrating a driving state determined as a state driving in a collision risk area, according to an embodiment of the present disclosure;

FIG. 10 is a diagram illustrating a driving state determined as a state driving in a collision area, according to an embodiment of the present disclosure;

FIG. 11 is a flowchart illustrating a maximum deceleration-based vehicle control method, according to another embodiment of the present disclosure, according to an embodiment of the present disclosure; and

FIG. 12 illustrates a computing system according to an embodiment of the present disclosure.

### DETAILED DESCRIPTION

Hereinafter, embodiments of the present disclosure are described in detail with reference to the accompanying drawings. In the accompanying drawings, identical or equivalent components are designated by the identical numerals even where the components are displayed on different drawings. Further, in the following description, a detailed description of a related known configuration or function has been omitted where the subject matter of the present disclosure may be obscured thereby.

In describing the components of the embodiment according to the present disclosure, terms such as first, second, A, B, (a), (b), and the like may be used. These terms are merely intended to distinguish the components from other components. The terms do not limit the nature, order or sequence of the components. Unless otherwise defined, all terms including technical and scientific terms used herein have the same meaning as commonly understood by one having ordinary skill in the art to which this disclosure pertains. It should be further understood that terms, such as those defined in commonly used dictionaries, should be interpreted as having a meaning that is consistent with their meaning in the context of the relevant art and should not be interpreted in an idealized or overly formal sense unless expressly so defined herein.

When a component, device, element, or the like of the present disclosure is described as having a purpose or performing an operation, function, or the like, the component, device, or element should be considered herein as being “configured to” meet that purpose or perform that operation or function.

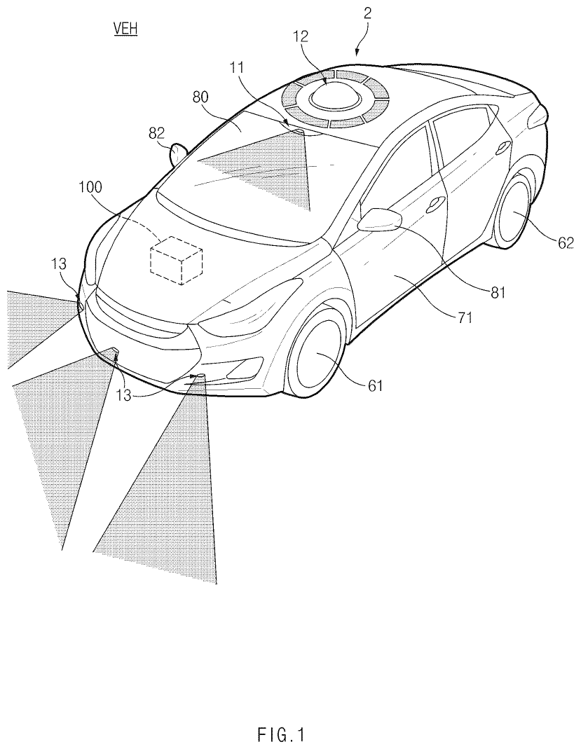

Hereinafter, embodiments of the present disclosure are described in detail with reference to FIGS. 1-12.

FIG. 1 is a diagram illustrating a vehicle including a vehicle control device, according to an embodiment of the present disclosure. The vehicle according to an embodiment of the present disclosure may be an autonomous vehicle capable of performing level 1 to level 5 autonomous driving.

Referring to FIG. 1, a vehicle VEH according to an embodiment of the present disclosure may include a main body 2, wheels 61 and 62, a door 71, a windshield 80, side mirrors 81 and 82, a sensor device 10, and a processor 100.

The vehicle VEH may be an electrification-based vehicle such as an electric vehicle (EV), a hybrid electric vehicle (HEV), a plug-in hybrid electric vehicle (PHEV), or a fuel cell electric vehicle (FCEV).

The main body 2 may be a structure that forms an outer appearance of the vehicle VEH.

The wheels 61 and 62 may include the front wheel 61 disposed at a front portion of the vehicle and the rear wheel 62 disposed at a rear portion of the vehicle. The front wheel 61 and the rear wheel 62 may be rotated by a driving device to move the vehicle VEH.

The door 71 may be pivotably disposed at each of left and right sides of the main body 2, so that an occupant may board the vehicle VEH when the door 71 is opened and the interior of the vehicle VEH may be shielded from the exterior of the vehicle VEH when the door 71 is closed.

The windshield 80 may be a type of windscreen. The windshield 80 may be disposed at a front upper side of the main body 2 to provide information about a front view of the vehicle VEH to a driver or a user inside the vehicle VEH.

The side mirrors 81 and 82 may include the left side mirror 81 disposed at the left side of the main body 2 and the right side mirror 82 disposed at the right side of the main body 2. The side mirrors 81 and 82 may provide information about side and rear views of the vehicle VEH to the driver inside the vehicle VEH.

The sensor device 10 may include a camera 11, a LIDAR 12, an ultrasonic sensor 13, or the like. Positions where the camera 11, the LIDAR 12, and the ultrasonic sensor 13 are formed may not be limited to those in FIG. 1.

The processor 100 may execute an algorithm for driving control based on a maximum deceleration, according to an embodiment of the present disclosure.

A detailed configuration of a vehicle control device, according to an embodiment of the present disclosure, is as follows.

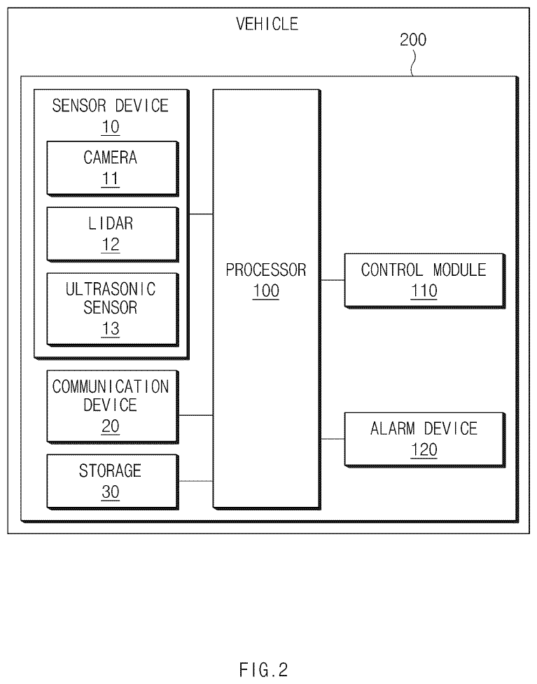

FIG. 2 is a block diagram showing a configuration of a vehicle control device, according to an embodiment of the present disclosure. A vehicle control device 200 according to an embodiment of the present disclosure may be implemented inside the vehicle. For example, the vehicle control device 200 may be integrally formed with internal control units of the vehicle or may be implemented as a separate device and connected to the control units of the vehicle by separate connection means.

Referring to FIG. 2, the vehicle control device 200 may include the sensor device 10, a communication device 20, storage 30, the processor 100, a control module 110, and an alarm device 120.

The sensor device 10 may include the camera 11, the light imaging detection and ranging (LIDAR) 12, and the ultrasonic sensor 13 for detecting objects outside the vehicle, such as vehicles located in front of or at the rear of the vehicle.

The camera 11 may be located at an appropriate place on an outer side of the vehicle. For example, the camera 11 may be located at the front portion, at the rear portion, on the right side mirror, and/or on the left side mirror of the vehicle to obtain an image of an external area of the vehicle. The camera may be a mono camera, a stereo camera, an around view monitoring (AVM) camera, or a 360-degree camera.

The camera 11 may be placed inside the vehicle, proximate to the front windshield or around a front bumper or a radiator grill, to obtain an image of an area in front of the vehicle.

The camera 11 may be placed inside the vehicle, proximate to at least one of side windows, to obtain an image of an area on a side of the vehicle. Additionally or alternatively, the camera 11 may be placed around a fender or the door.

The LIDAR 12 may include laser transmission and reception modules. The LIDAR may be implemented in a time of flight (TOF) scheme or a phase-shift scheme. The LIDAR may be exposed to the outside of the vehicle to detect an object located in front of, at the rear of, or on the side of the vehicle.

The ultrasonic sensor 13 may include ultrasonic transmission and reception modules. The ultrasonic sensor 13 may detect the object based on an ultrasonic wave. The ultrasonic sensor 13 may detect a position of the detected object, a distance to the detected object, and a relative speed with respect to the detected object. The ultrasonic sensor 13 may be placed at an appropriate place on the outer side of the vehicle to detect the object located in front of, at the rear of, or on the side of the vehicle.

Additionally or alternatively, the sensor device 10 may include a radio detection and ranging (RADAR) or an infrared sensor.

The RADAR may include electromagnetic wave transmission and reception modules. The RADAR may be implemented in a pulse radar scheme or a continuous wave radar scheme in terms of a radio wave emission principle. The RADAR may be implemented in a frequency modulated continuous wave (FMCW) scheme or a frequency shift keying (FSK) scheme of the continuous wave RADAR scheme based on a signal waveform. The RADAR may detect the object based on a time of flight (TOF) scheme or a phase-shift scheme using an electromagnetic wave as a medium. The RADAR may detect the position of the detected object, the distance to the detected object, and the relative speed with respect to the detected object.

The infrared sensor may include infrared transmission and reception modules. The infrared sensor may detect the object based on infrared light and detect the position of the detected object, the distance to the detected object, and the relative speed with respect to the detected object. The infrared sensor may be placed on the outer side of the vehicle to detect the object located in front of, at the rear of, or on the side of the vehicle.

The sensor device 10 may further include a brake-pedal position sensor (BPS) and an accelerator position sensor (APS) that generate a speed control command for changing a speed of the vehicle.

The brake-pedal position sensor may output a BPS signal based on a degree of depression of a brake pedal equipped in the vehicle. For example, the BPS signal may output data of a value in a range from 0 to 100 based on the depression of the brake pedal. In an example, a value of 0 may be output when the brake pedal is not pressed and a value of 100 may be output when the brake pedal is maximally pressed.

The accelerator position sensor may output an APS signal based on a degree of depression of an accelerator pedal equipped in the vehicle. As an example, the APS signal may output data of a value in a range from 0 to 100 based on the depression of the accelerator pedal. In an example, a value of 0 may be output when the accelerator pedal is not pressed and a value of 100 may be output when the accelerator pedal is maximally pressed.

The communication device 20 may perform communication with a user terminal, another vehicle, and/or an external server. According to an embodiment, the communication device 20 may receive maximum deceleration information from a preceding vehicle.

The communication device 20 may perform short range communication, GPS signal reception, V2X communication, optical communication, broadcast transmission and reception, and/or intelligent transport system (ITS) communication functions.

The communication device 20 may support the short range communication using at least one of Bluetooth, radio frequency identification (RFID), infrared data association (IrDA), ultra-wideband (UWB), ZigBee, near field communication (NFC), wireless-fidelity (Wi-Fi), Wi-Fi Direct, or wireless universal serial bus (Wireless USB) technologies.

The communication device 20 may include a global positioning system (GPS) module or a differential global positioning system (DGPS) module for obtaining position information.

In an embodiment, the communication device 20 may include a V2X communication module. The V2X communication module may include an RF circuit for a protocol of wireless communication with a server (vehicle to infra; V2I), another vehicle (vehicle to vehicle; V2V), and/or a pedestrian (vehicle to pedestrian; V2P).

The communication device 20 may transmit/receive a wireless signal to/from at least one of a base station, an external terminal, or a center on a mobile communication network built based on technical standards or communication schemes for mobile communication. For example, the communication device 20 may perform the communication based on a global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), and/or long term evolution-advanced (LTE-A). The wireless signal may include a voice call signal, a video call signal, or various types of data based on text/multimedia message transmission/reception.

The storage 30 may store algorithms and an AI processor for operation of the processor 100. As the storage 30, a hard disk drive, a flash memory, an electrically erasable programmable read-only memory (EEPROM), a static RAM (SRAM), a ferro-electric RAM (FRAM), a phase-change RAM (PRAM), a magnetic RAM (MRAM), a dynamic random access memory (DRAM), a synchronous dynamic random access memory (SDRAM), a double data rate-SDRAM (DDR-SDRAM), or the like may be used.

The processor 100 may determine a risk of collision of the vehicle VEH. The processor 100 may control the control module 110 of the vehicle VEH based on a maximum deceleration of the preceding vehicle. The vehicle to which an embodiment of the present disclosure is applied may be referred to as a host vehicle.

In an embodiment, the processor 100 may detect the preceding vehicle using the sensor device 10 and may determine the maximum deceleration of the preceding vehicle. For example, the processor 100 may receive the maximum deceleration information from the preceding vehicle. Alternatively, the processor 100 may perform artificial intelligence learning with a size and a manufacturer of the preceding vehicle as input values and output the maximum deceleration.

In addition, the processor 100 may calculate a braking distance and a safe stopping distance of the preceding vehicle based on the maximum deceleration. The braking distance of the preceding vehicle may be calculated to be inversely proportional to the maximum deceleration. The safe stopping distance, as a criterion for determining the risk of collision when the vehicle VEH brakes suddenly, may be proportional to an inter-vehicle distance and the braking distance of the preceding vehicle.

In addition, the processor 100 may determine a risk of collision with the preceding vehicle based on the safe stopping distance and may control the control module based on the risk of collision. A detailed method for determining the risk of collision and controlling the control module, according to an embodiment, is described below.

The control module 110 may be configured to vary the speed and steering of the vehicle in response to a control signal from the processor 100. The control module 110 may include an engine control module, a braking control module, and a transmission control module.

The engine control module may be an actuator that controls an engine of the vehicle and controls acceleration of the vehicle. The engine control module may be implemented as an engine management system (EMS). The engine control module may control a driving torque of the engine based on accelerator pedal position information output from the accelerator position sensor. The engine control module may control output of the engine to follow a driving speed of the vehicle requested from the processor 100 during autonomous driving.

The braking control module may be an actuator that controls deceleration of the vehicle. The braking control module may be implemented as an electronic stability control (ESC), for example. The braking control module may control a braking pressure to follow a target speed requested from the processor 100. In other words, the braking control module may control the deceleration of the vehicle.

The transmission control module may be an actuator that controls a transmission of the vehicle. The transmission control module may be implemented as a shift by wire (SBW), for example. The transmission control module may control the speed change of the vehicle based on a gear position and a gear state range.

The alarm device 120 may be configured to notify the driver of a driving state of the vehicle. At least one of a display, a speaker, or haptic devices coupled to the steering wheel may be used as the alarm device 120.

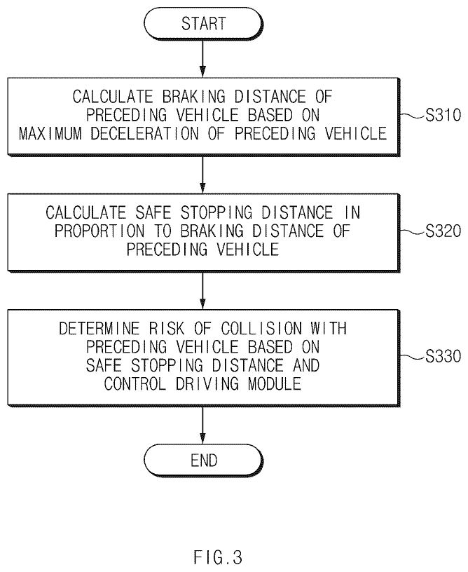

FIG. 3 is a flowchart illustrating a method for controlling a vehicle, according to an embodiment of the present disclosure. A procedure shown in FIG. 3 may be performed by the processor shown in FIG. 2. Hereinafter, referring to FIG. 3, the method for controlling the vehicle according to an embodiment of the present disclosure is described as follows.

In an operation S310, the processor 100 may calculate a braking distance of a preceding vehicle based on a maximum deceleration of the preceding vehicle.

A maximum deceleration of a vehicle may refer to a deceleration of the vehicle when a braking force is maximum.

The processor 100 may receive the maximum deceleration via the communication device 20. Additionally or alternatively, the processor 100 may estimate the maximum deceleration based on AI learning.

In an operation S320, the processor 100 may calculate a safe stopping distance in proportion to the braking distance of the preceding vehicle.

The processor 100 may calculate an inter-vehicle distance and a braking distance of the preceding vehicle to calculate the safe stopping distance. In addition, a safe stopping margin distance may be calculated based on the braking distance of the preceding vehicle. The safe stopping margin distance may be a margin distance of the braking distance in a process in which the preceding vehicle stops with the maximum deceleration. The safe stopping margin distance may be obtained by subtracting a collision-avoiding safety distance ‘X’ from a braking distance Df of the preceding vehicle. The collision-avoiding safety distance ‘X’ may be a minimum distance required for avoiding a collision with the preceding vehicle. The collision-avoiding safety distance ‘X’ may be set in advance.

The processor 100 may calculate the safe stopping distance by calculating a sum of the inter-vehicle distance and the safe stopping margin distance.

In and operation S330, the processor 100 may determine a risk of collision based on the safe stopping distance and may control a driving module based on the risk of collision.

When the safe stopping distance exceeds a stopping distance, the processor 100 may determine that the vehicle VEH is in a safe driving state with respect to the preceding vehicle. When the vehicle VEH is in the safe driving state, the processor 100 may control the driving state such that the inter-vehicle distance between the vehicle VEH and the preceding vehicle is not reduced.

The processor 100 may determine that the vehicle VEH is located within an area with the risk of collision with the preceding vehicle when the stopping distance is equal to or greater than the safe stopping distance and when the stopping distance is smaller than a sum of the safe stopping distance and the collision safety distance. When it is determined that the vehicle VEH is within the collision risk area, the processor 100 may output an alarm via the alarm device 120 and determine whether a lane change is possible.

When the stopping distance is greater than the sum of the safe stopping distance and the collision safety distance, the processor 100 may determine that the vehicle VEH is located within a collision area. When it is determined that the vehicle VEH is within the collision area, the processor 100 may attempt to perform the lane change. When the lane change is impossible because of vehicles driving in an adjacent line, the processor 100 may decelerate the vehicle VEH.

Hereinafter, the procedures shown in FIG. 3, according to an embodiment, are described in more detail.

The processor 100 may receive the maximum deceleration information from the preceding vehicle to identify the maximum deceleration.

Alternatively, when the preceding vehicle does not have the maximum deceleration information or the communication is impossible, the processor 100 may estimate the maximum deceleration via AI learning based on the size and the manufacturer of the preceding vehicle.

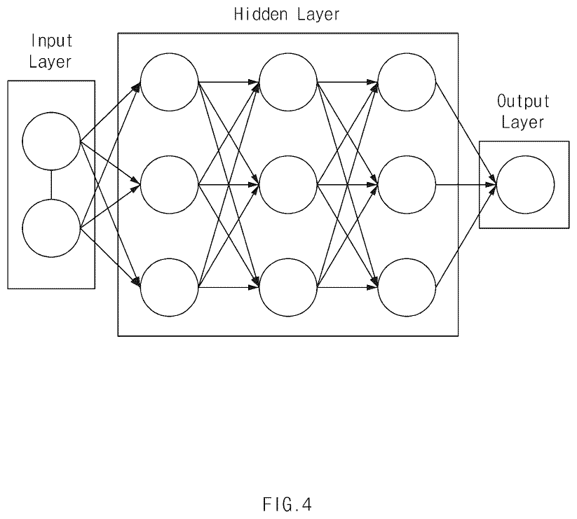

FIG. 4 is a diagram illustrating an artificial neural network (ANN) for setting a maximum deceleration, according to an embodiment of the present disclosure.

The processor 100 may obtain the maximum deceleration using the artificial neural network shown in FIG. 4. The artificial neural network may be stored in the processor 100 or the storage.

The artificial neural network mathematically models a form in which human neurons are connected to each other. The artificial neural network may include an input layer, a hidden layer, and an output layer.

The input layer may multiply input data by a weight matrix and provide the result to the hidden layer. The input data may be variables used to set the maximum deceleration. For example, the input data may include at least one of a vehicle size, a manufacturer, and a vehicle type.

The hidden layer may process the input data based on an activation function. In addition, the hidden layer may multiply the processed input data by a new weight matrix and pass the result to the output layer.

The output layer may output a result by reflecting an activation function for output. The output layer may output the maximum deceleration as an output value.

In an embodiment, the processor 100 may update an AI algorithm for obtaining the maximum deceleration based on reinforcement learning. For example, after determining the risk of collision of the vehicle based on the maximum deceleration obtained via the AI learning, the AI algorithm may be optimized by receiving feedback indicating whether the risk of collision determination was appropriate.

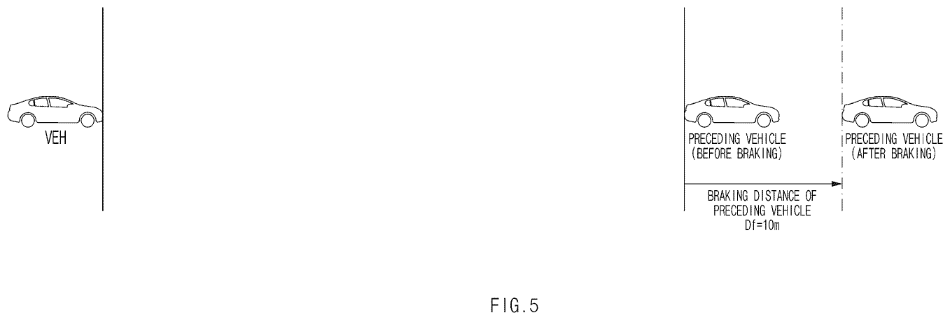

FIG. 5 is a diagram illustrating a braking distance, according to an embodiment. Referring to FIG. 5, a method for calculating the braking distance of the preceding vehicle in S310, according to an embodiment, is described as follows.

The processor 100 may calculate a braking distance that the preceding vehicle drives when the preceding vehicle brakes based on the maximum deceleration. For example, when the preceding vehicle is driving at 36 km/h (10 m/s) and the maximum deceleration of the preceding vehicle is −5 m/s², the processor 100 may calculate that the braking distance Df of the preceding vehicle is 10 m.

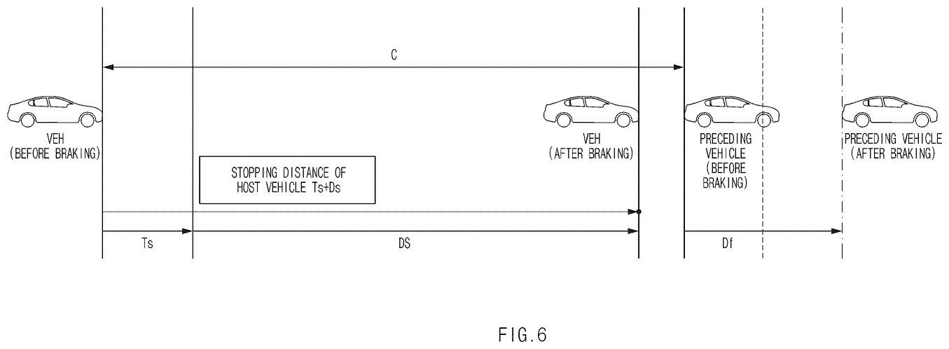

FIG. 6 is a diagram illustrating a stopping distance, according to an embodiment. Referring to FIG. 6, a method for calculating a stopping distance of the vehicle, according to an embodiment, is described as follows.

To calculate the stopping distance, the processor 100 may calculate a free running distance of the vehicle VEH. The free running distance may be set to a great value in proportion to the driving speed of the vehicle VEH. In an example, the free running distance may be matched to the driving speed of the vehicle and stored in a lookup table. In another example, the processor 100 may calculate the free running distance based on the driving speed of the vehicle.

The processor 100 may calculate a braking distance of the vehicle VEH. The braking distance of the vehicle VEH may refer to a moving distance until the vehicle VEH stops when the braking force is applied with the maximum magnitude. The processor 100 may calculate the braking distance based on a maximum deceleration and a driving speed in the state in which the braking force is maximum. For example, when the vehicle VEH is driving at 72 km/h (20 m/s) and a maximum deceleration of the vehicle VEH is −5 m/s², the processor 100 may calculate that a braking distance Ds of the vehicle VEH is 40 m.

The processor 100 may obtain the stopping distance by calculating a sum of the free running distance Ts and the braking distance Ds of the vehicle VEH.

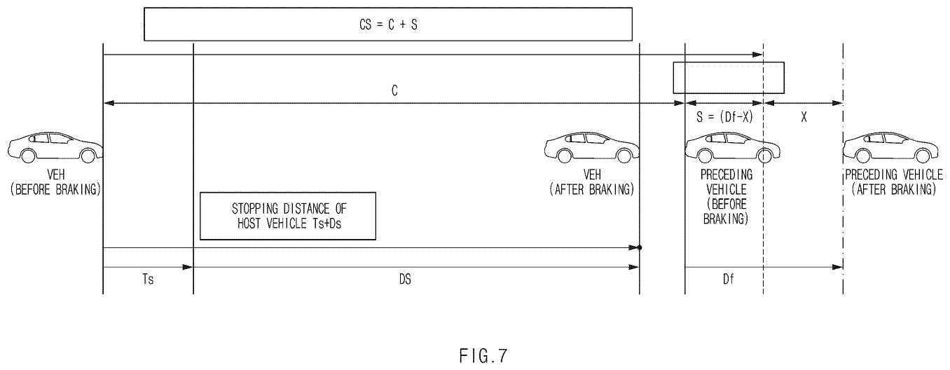

FIG. 7 is a diagram illustrating a safe stopping distance, according to an embodiment. Referring to FIG. 7, a method for calculating a safe stopping distance of the vehicle, according to an embodiment, is described as follows.

To calculate the safe stopping distance, the processor 100 may calculate an inter-vehicle distance ‘C’ and a safe stopping margin distance ‘S’.

The processor 100 may calculate the inter-vehicle distance ‘C’ of the preceding vehicle detected via the sensor device 10.

In addition, the processor 100 may calculate the safe stopping margin distance ‘S’. The safe stopping margin distance ‘S’ may be obtained by subtracting the collision-avoiding safety distance ‘X’ from the braking distance Df of the preceding vehicle. The collision-avoiding safety distance ‘X’ may be a margin distance for avoiding a collision with the preceding vehicle.

In addition, the processor 100 may obtain a safe stopping distance ‘CS’ by calculating a sum of the inter-vehicle distance ‘C’ and the safe stopping margin distance ‘S’.

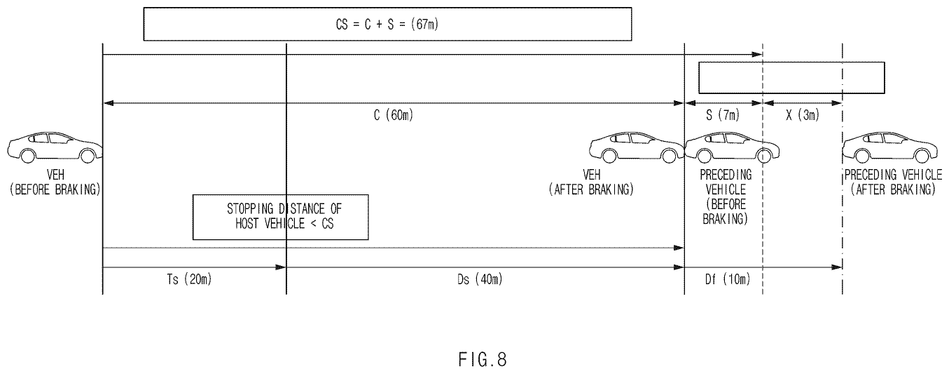

FIGS. 8 to 10 are diagrams illustrating embodiments of determining a risk of collision of a vehicle based on a safe stopping distance. Hereinafter, with reference to FIGS. 8 to 10, the embodiments of determining the risk of collision of the vehicle based on the safe stopping distance are described as follows.

FIG. 8 is a diagram illustrating a driving state determined as a state driving in a safe driving area, according to an embodiment.

FIG. 8 illustrates an example in which the inter-vehicle distance is 60 m, the collision-avoiding safety distance is 3 m, the speed of the vehicle VEH is 72 km/h (20 m/s), the maximum deceleration of the vehicle VEH is −5 m/s, the speed of the preceding vehicle is 36 km/h (10 m/s) and the maximum deceleration of the preceding vehicle is −5 m/s².

Accordingly, the processor 100 may calculate the braking distance Ds of the vehicle VEH as 40 m and the free running distance Ts as 20 m based on the speed and the maximum deceleration of the vehicle VEH. In addition, the processor 100 may calculate the stopping distance of the vehicle VEH as 60 m by calculating a sum of the free running distance Ts and the braking distance Ds of the vehicle.

In addition, the processor 100 may calculate the braking distance Df of the preceding vehicle as 10 m based on the speed and the maximum deceleration of the preceding vehicle. In addition, the processor 100 may calculate the safe stopping margin distance ‘S’ as 7 m by subtracting the collision-avoiding safety distance ‘X’ from the braking distance Df of the preceding vehicle. In addition, the processor 100 may calculate the safe stopping distance CS as 67 m by calculating a sum of the inter-vehicle distance ‘C’ and the safe stopping margin distance ‘S’.

As a result, because the safe stopping distance CS is 67 m and the stopping distance of the vehicle VEH is 60 m, the processor 100 may determine that the safe stopping distance CS is greater than the stopping distance of the vehicle VEH. As such, when the safe stopping distance CS of the vehicle VEH exceeds the stopping distance, the processor 100 may determine that the vehicle VEH is driving in the safe driving area.

When the vehicle VEH is located in the safe driving area, the processor 100 may be not involved in an operation of the control module 110. Alternatively, the processor 100 may assist the operation of the control module 110 such that the distance between the vehicle VEH and the preceding vehicle is not reduced.

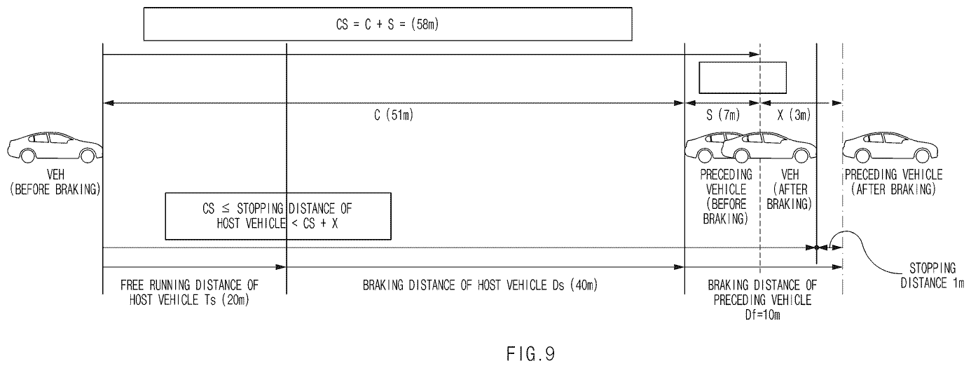

FIG. 9 is a diagram illustrating a driving state determined as a state driving in a collision risk area, according to an embodiment.

FIG. 9 illustrates an example in which the inter-vehicle distance is 51 m, the collision-avoiding safety distance is 3 m, the speed of the vehicle VEH is 72 km/h (20 m/s), the maximum deceleration of the vehicle VEH is −5 m/s, the speed of the preceding vehicle is 36 km/h (10 m/s), and the maximum deceleration of the preceding vehicle is −5 m/s².

Accordingly, the processor 100 may calculate the braking distance Ds of the vehicle VEH as 40 m and the free running distance Ts as 20 m based on the speed and the maximum deceleration of the vehicle VEH. In addition, the processor 100 may calculate the stopping distance of the vehicle VEH as 60 m by calculating a sum of the free running distance Ts and the braking distance Ds of the vehicle.

In addition, the processor 100 may calculate the braking distance Df of the preceding vehicle as 10 m based on the speed and the maximum deceleration of the preceding vehicle. In addition, the processor 100 may calculate the safe stopping margin distance ‘S’ as 7 m by subtracting the collision-avoiding safety distance ‘X’ from the braking distance Df of the preceding vehicle. In addition, the processor 100 may calculate the safe stopping distance CS as 58 m by calculating a sum of the inter-vehicle distance ‘C’ and the safe stopping margin distance ‘S’.

As a result, the safe stopping distance CS may be obtained as 58 m, the stopping distance of the vehicle VEH may be obtained as 60 m, and a sum of the safe stopping distance CS and the collision-avoiding safety distance ‘X’ may be obtained as 61 m. Accordingly, the processor 100 may determine that the stopping distance of the vehicle VEH is equal to or greater than the safe stopping distance CS and falls within a range smaller than the sum of the safe stopping distance CS and the collision-avoiding safety distance ‘X’. Thus, the processor 100 may determine that the vehicle VEH is driving in the collision risk area.

The processor 100 may output an alarm via the alarm device 120 when the vehicle VEH is located in the collision risk area.

In addition, the processor 100 may determine whether a lane change is possible when the vehicle VEH is located in the collision risk area. When the vehicle VEH is located in the collision risk area, the procedure for determining whether a lane change is possible may be a preliminary procedure for faster lane change when the safe stopping distance CS is further reduced.

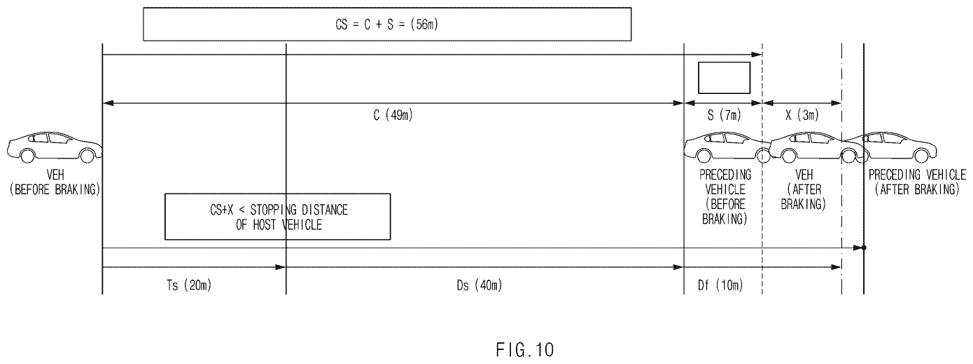

FIG. 10 is a diagram illustrating a driving state determined as a state driving in a collision area, according to an embodiment.

FIG. 10 illustrates an example in which the inter-vehicle distance is 49 m, the collision-avoiding safety distance is 3 m, the speed of the vehicle VEH is 72 km/h (20 m/s), the maximum deceleration of the vehicle VEH is −5 m/s², the speed of the preceding vehicle is 36 km/h (10 m/s), and the maximum deceleration of the preceding vehicle is −5 m/s².

Accordingly, the processor 100 may calculate the braking distance Ds of the vehicle VEH as 40 m and the free running distance Ts as 20 m based on the speed and the maximum deceleration of the vehicle VEH. In addition, the processor 100 may calculate the stopping distance of the vehicle VEH as 60 m by calculating a sum of the free running distance Ts and the braking distance Ds of the vehicle.

In addition, the processor 100 may calculate the braking distance Df of the preceding vehicle as 10 m based on the speed and the maximum deceleration of the preceding vehicle. In addition, the processor 100 may calculate the safe stopping margin distance ‘S’ as 7 m by subtracting the collision-avoiding safety distance ‘X’ from the braking distance Df of the preceding vehicle. In addition, the processor 100 may calculate the safe stopping distance CS as 56 m by calculating a sum of the inter-vehicle distance ‘C’ and the safe stopping margin distance ‘S’.

As a result, the safe stopping distance CS may be obtained as 56 m, the stopping distance of the vehicle VEH may be obtained as 60 m, and the sum of the safe stopping distance CS and the collision-avoiding safety distance ‘X’ may be obtained as 59 m. Accordingly, the processor 100 may determine that the stopping distance of the vehicle VEH is greater than the sum of the safe stopping distance CS and the collision-avoiding safety distance ‘X’. Thus, the processor 100 may determine that the vehicle VEH is driving in the collision area.

The processor 100 may attempt to perform the lane change when the vehicle VEH is located in the collision area.

The processor 100 may control the control module 110 to reduce the speed of the vehicle VEH when it is impossible to perform the lane change for the vehicle VEH to escape from the collision area.

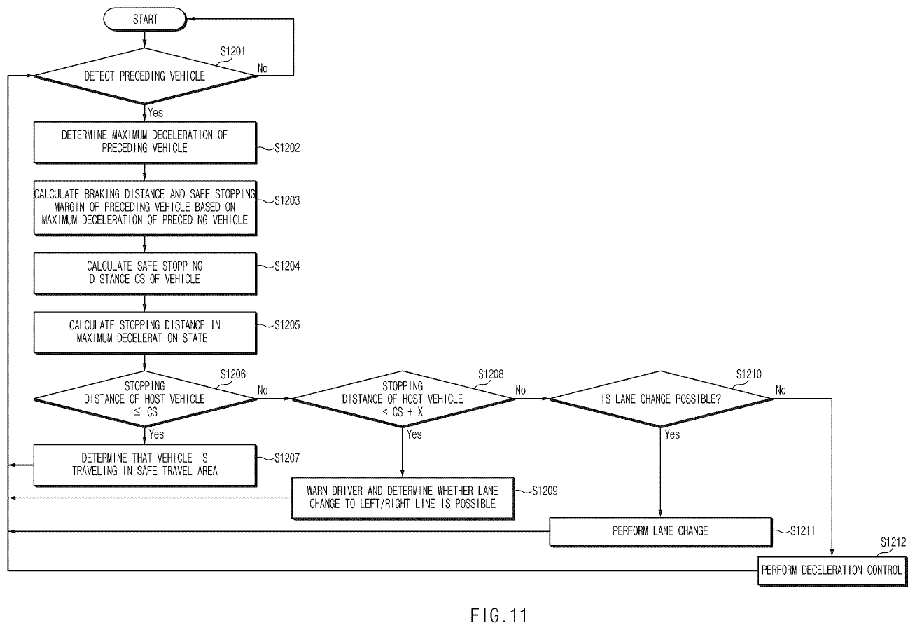

FIG. 11 is a flowchart illustrating a maximum deceleration-based vehicle control method, according to another embodiment of the present disclosure.

Referring to FIG. 11, a vehicle control method according to another embodiment of the present disclosure, according to an embodiment, is described as follows.

In an operation S1201, the processor 100 of the vehicle VEH may detect a preceding vehicle. The vehicle VEH may detect the preceding vehicle via the sensor device 10.

In an operation S1202, the processor 100 may determine a maximum deceleration of the preceding vehicle.

The processor 100 may receive the maximum deceleration information from the preceding vehicle via the V2X communication. Additionally or alternatively, the processor 100 may estimate the maximum deceleration via AI learning based on information of the preceding vehicle obtained via the sensor device 10.

Alternatively, the processor 100 may identify a maximum deceleration matching a size of the preceding vehicle based on maximum decelerations corresponding to vehicle sizes stored in advance, e.g., in a memory coupled to the processor.

In an operation S1203, the processor 100 may calculate a braking distance Df and a safe stopping margin distance ‘S’ of the preceding vehicle based on the maximum deceleration of the preceding vehicle.

The safe stopping margin distance ‘S’ may be obtained by subtracting the collision-avoiding safety distance ‘X’ from the braking distance Df of the preceding vehicle. The collision-avoiding safety distance ‘X’ may be preset.

In an operation S1204, the processor 100 may calculate a safe stopping distance CS of the vehicle VEH.

The safe stopping distance CS may be calculated by calculating a sum of the inter-vehicle distance ‘C’ and the safe stopping margin distance ‘S’.

In an operation S1205, the processor 100 may calculate a stopping distance in the maximum deceleration state of the vehicle VEH.

The stopping distance may be obtained by calculating a sum of the free running distance Ts and the braking distance Ds of the vehicle VEH. The free running distance Ts and the braking distance Ds may be determined based on the driving speed and the maximum deceleration of the vehicle VEH.

In an operation S1206, the processor 100 may compare the stopping distance of the vehicle VEH with the safe stopping distance CS.

In an operation S1207, when the stopping distance of the vehicle VEH does not exceed the safe stopping distance CS, the processor 100 may determine that the vehicle VEH is driving in the safe driving area.

In an operation S1208, when the stopping distance of the vehicle VEH is equal to or greater than the safe stopping distance CS, the processor 100 may compare the stopping distance of the vehicle VEH with the sum of the safe stopping distance and the collision-avoiding safety distance ‘X’.

In an operation S1209, when the stopping distance of the vehicle VEH is smaller than the sum of the safe stopping distance CS and the collision-avoiding safety distance ‘X’, the processor 100 may determine that the vehicle VEH is driving in the collision risk area. In this case, the processor 100 may output an alarm to the driver. The processor 100 may also determine whether a lane change is possible.

In operations S1210 and S1211, when the stopping distance of the vehicle VEH is equal to or greater than the sum of the safe stopping distance CS and the collision-avoiding safety distance ‘X’, the processor 100 may determine that the vehicle VEH is driving in the collision area. When the vehicle VEH is located in the collision area, the processor 100 may determine the possibility of a lane change. The processor 100 may perform the lane change when the lane change is possible.

In an operation S1212, when the vehicle VEH is driving in the collision area, but the lane change is impossible, the processor 100 may decelerate the vehicle VEH.

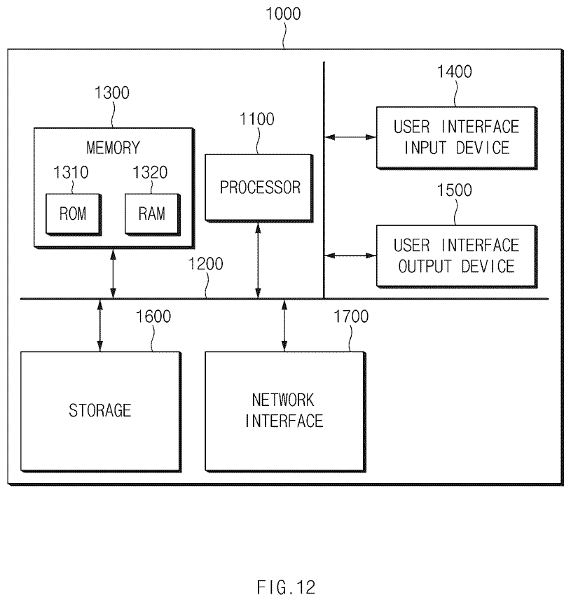

FIG. 12 illustrates a computing system, according to an embodiment of the present disclosure.

With reference to FIG. 12, a computing system 1000 may include at least one processor 1100, a memory 1300, a user interface input device 1400, a user interface output device 1500, storage 1600, and a network interface 1700 connected via a bus 1200.

The processor 1100 may be a central processing unit (CPU) or a semiconductor device that performs processing on commands stored in the memory 1300 and/or the storage 1600. The memory 1300 and the storage 1600 may include various types of volatile or non-volatile storage media. For example, the memory 1300 may include a ROM (Read Only Memory) and a RAM (Random Access Memory).

Thus, the operations of the method or the algorithm described in connection with the embodiments disclosed herein may be embodied directly in hardware or a software module executed by the processor 1100, or in a combination thereof. The software module may reside on a storage medium (e.g., the memory 1300 and/or the storage 1600) such as a RAM, a flash memory, a ROM, an EPROM, an EEPROM, a register, a hard disk, a removable disk, and a CD-ROM.

The storage medium may be coupled to the processor 1100, which may read information from, and write information to, the storage medium. In another example, the storage medium may be integral with the processor 1100. The processor and the storage medium may reside within an application specific integrated circuit (ASIC). The ASIC may reside within the user terminal. In another example, the processor and the storage medium may reside as individual components in the user terminal.

The description above is merely illustrative of the technical idea of the present disclosure. Various modifications and changes may be made by those having ordinary skill in the art without departing from the essential characteristics of the present disclosure.

Therefore, the embodiments disclosed in the present disclosure are not intended to limit the technical idea of the present disclosure but are merely intended to illustrate the present disclosure. The scope of the technical idea of the present disclosure is not limited by the embodiments. The scope of the present disclosure should be construed as being covered by the scope of the appended claims, and all technical ideas falling within the scope of the claims should be construed as being included in the scope of the present disclosure.

According to embodiments of the present disclosure, the risk of collision may be determined based on the sudden braking performance to notify the driver of the safety of the vehicle.

In addition, according to embodiments of the present disclosure, the vehicle may be safely controlled by avoiding the risk of collision based on the sudden braking performance.

In addition, various effects identified directly or indirectly through the present disclosure may be provided.

Hereinabove, although the present disclosure has been described with reference to example embodiments and the accompanying drawings, the present disclosure is not limited thereto. The present disclosure may be variously modified and altered by those having ordinary skill in the art to which the present disclosure pertains without departing from the spirit and scope of the present disclosure claimed in the following claims.

What is claimed is:

1. A device for controlling a vehicle, the device comprising:
a sensor device configured to detect a preceding vehicle of the vehicle;
a control module configured to control driving and steering of the vehicle; and
a processor configured to
calculate a braking distance of the preceding vehicle based on a maximum deceleration of the preceding vehicle,
calculate a safe stopping distance for providing a criterion for determining a risk of collision in a case of sudden braking in proportion to the braking distance of the preceding vehicle,
determine a risk of collision with the preceding vehicle based on the safe stopping distance, and
control the control module based on the risk of collision.

2. The device of claim 1, further comprising:
a communication device configured to receive information on the maximum deceleration from the preceding vehicle.

3. The device of claim 1, wherein the processor is configured to output the maximum deceleration via artificial intelligence learning with a size and a manufacturer of the preceding vehicle as input values.

4. The device of claim 1, wherein the processor is configured to calculate the safe stopping distance based on an inter-vehicle distance with the preceding vehicle and the braking distance of the preceding vehicle.

5. The device of claim 4, wherein the processor is configured to:
determine a safe stopping margin distance by calculating a difference between the braking distance of the preceding vehicle and a preset collision-avoiding safety distance; and
calculate the safe stopping distance by calculating a sum of the inter-vehicle distance and the safe stopping margin distance.

6. The device of claim 5, wherein the processor is configured to control the control module to maintain a driving state such that the inter-vehicle distance is not reduced when the safe stopping distance exceeds a stopping distance.

7. The device of claim 6, wherein the processor is configured to determine that the vehicle is located within a collision risk area and output an alarm via an alarm device when the stopping distance is equal to or greater than the safe stopping distance and is smaller than a sum of the safe stopping distance and the collision-avoiding safety distance.

8. The device of claim 7, wherein the processor is configured to determine whether a lane change is possible when it is determined that the vehicle is within the collision risk area.

9. The device of claim 7, wherein the processor is configured to determine that the vehicle is located within a collision area and attempt to perform a lane change when the stopping distance is equal to or greater than the sum of the safe stopping distance and the collision-avoiding safety distance.

10. The device of claim 9, wherein the processor is configured to decelerate the vehicle when the lane change is impossible.

11. A method for controlling a vehicle, the method comprising:
identifying a maximum deceleration of a preceding vehicle;
calculating a braking distance of the preceding vehicle based on the maximum deceleration of the preceding vehicle;
calculating a safe stopping distance for providing a criterion for determining a risk of collision in a case of sudden braking in proportion to the braking distance of the preceding vehicle;
determining a risk of collision with the preceding vehicle based on the safe stopping distance; and
controlling a control module, configured to control driving and steering of the vehicle, based on the risk of collision.

12. The method of claim 11, wherein identifying the maximum deceleration of the preceding vehicle includes:
receiving, via a communication device, information on the maximum deceleration from the preceding vehicle.

13. The method of claim 11, wherein identifying the maximum deceleration of the preceding vehicle includes:
outputting the maximum deceleration via artificial intelligence learning with a size and a manufacturer of the preceding vehicle as input values.

14. The method of claim 11, wherein calculating the safe stopping distance includes:
calculating the safe stopping distance based on an inter-vehicle distance with the preceding vehicle and the braking distance of the preceding vehicle.

15. The method of claim 14, wherein calculating the safe stopping distance includes:
calculating the inter-vehicle distance;
obtaining a safe stopping margin distance by calculating a difference between the braking distance of the preceding vehicle and a preset collision-avoiding safety distance; and
calculating the safe stopping distance by calculating a sum of the inter-vehicle distance and the safe stopping margin distance.

16. The method of claim 15, wherein controlling the control module based on the risk of collision includes:
maintaining a driving state such that the inter-vehicle distance is not reduced when the safe stopping distance exceeds a stopping distance.

17. The method of claim 16, wherein controlling the control module based on the risk of collision further includes:
outputting an alarm notifying that the vehicle is located within a collision risk area when the stopping distance is equal to or greater than the safe stopping distance and is smaller than a sum of the safe stopping distance and the collision-avoiding safety distance.

18. The method of claim 17, wherein controlling the control module based on the risk of collision further includes:
determining whether a lane change is possible when it is determined that the vehicle is within the collision risk area.

19. The method of claim 17, wherein controlling the control module based on the risk of collision further includes:
determining that the vehicle is located within a collision area and attempt to perform a lane change when the stopping distance is equal to or greater than the sum of the safe stopping distance and the collision-avoiding safety distance.

20. The method of claim 19, wherein controlling the control module based on the risk of collision further includes:
decelerating the vehicle when the lane change is impossible.
